(19) United States
(12) Patent Application Publication
(10) Pub. No.: US 2006/0222228 A1
(43) Pub. Date: Oct. 5, 2006

(54) Bone density screening and mammography CAD system

(76) Inventors: Kevin J. Hobert, Pittsford, NY (US); Terese M. Bogucki, Oakland, CA (US); Wido Menhardt, Los Gatos, CA (US)

Correspondence Address: Pamela R. Crocker;Patent Legal Staff, Eastman Kodak Company, 343 State Street, Rochester, NY, 14650-2201, US

(21) Appl. No.: 11/390,408

(22) Filed: Mar. 27, 2006

Related U.S. Application Data
(60) Provisional application No. 60/666,123, filed on Mar. 29, 2005.

(51) Int. Cl. G06K 9/00

(52) U.S. Cl. 382/132

(57) ABSTRACT

A method and system adapted to analyze a radiograph for bone mineral density screening and mammography computer aided detection. The method of analyzing a radiograph includes the steps of: providing a digital image based on the radiograph; determining whether a radiographic absorptiometry analysis or computer aided detection analysis is desired; and performing a radiographic absorptiometry analysis or computer aided detection analysis on the digital image based on the desired determination. The system can include an input station, a report station, and a printer.

### CROSS REFERENCE TO RELATED APPLICATIONS

Reference is made to, and priority is claimed from, commonly assigned provisional application U.S. Ser. No. 60/666,123, entitled “BONE DENSITY SCREENING AND MAMMOGRAPHY CAD SYSTEM”, provisionally filed on Mar. 29, 2005 in the names of Hobert et al., and which is assigned to the assignee of this application.

### FIELD OF THE INVENTION

The invention relates generally to the field of computer aided detection (CAD). More specifically, the invention relates to an integrated system for Radiographic Absorptiometry (RA) based BMD (Bone Mineral Density) screening and Mammography CAD system for film-screen x-ray input.

### BACKGROUND OF THE INVENTION

Osteoporosis is a skeletal disorder characterized by reduced bone strength, which can result in increased risk of fractures, height loss, compression of the vertebrae, and pain.

Bone strength is a function of bone mineral density (BMD) and bone quality. It is believed that bone mineral density peaks about the age of 30 for both men and women, and then declines gradually. Some statistics have indicated that osteoporosis affects approximately 20 million people and causes about 1.3 million fracture incidents in the United States each year. Treatment of such fractures can result in medical expenses of about $14 billion (U.S). As such, screening for bone mineral density is often recommended, particularly for post-menopausal women.

Several common techniques have been used to measure bone mineral density, including bone puncture, radiographic absorptiometry using single energy x-ray systems, dual energy x-ray absorptiometry (DEXA), and quantitative ultrasound.

Bone puncture is an accurate but invasive procedure, which involves the extraction of bone mass from spine area. This procedure carries risk. Mineral loss in a person's bones can be estimated from a single energy x-ray image of a body part. In diagnosing and treating bone diseases, it is common to take radiographic images of the patient, e.g., skeletal features of the patient, then either read the images directly or perform software analysis on the images to extract information of interest. For example, in diagnosing or monitoring the treatment of osteoporosis, one might take x-ray images of selected skeletal bones, then perform computer analysis on certain image features to determine bone volume, bone length, bone geometric changes, bone strength conditions, bone age, bone cortical thickness, and bone mineral mass. For example, U.S. Pat. No. 6,246,745 (Bi) describes a software system for determining bone mineral density from radiographic images of a patient hand, using bone segmentation and contour analysis algorithms.

Typically, a treating physician will refer the patient to a radiologist, who will then supervise both taking the radiographic image and interpreting the image to extract desired bone information, such as bone mass and bone contour irregularities. Alternatively, if the bone analysis is done, at least partially, by a computer analysis system, the x-ray images prepared by the radiologist may be sent back to the treating physician's computer site or to another computer site for computer analysis.

DEXA measures bone mineral density (BMD) using two low-dosage x-ray beams at different energy levels aimed at the patient's spine, hip or whole body. A computer calculates the content of bone mineral density based on the how the bones have absorbed the two x-ray energy levels. DEXA is considered to be accurate, but the apparatus is bulky and expensive and emits radiation. See for example, U.S. Pat. No. 6,816,564 (Charles, Jr.) directed to a technique for deriving tissue structure from multiple projection dual-energy x-ray absorptiometry.

Quantitative ultrasound devices measure the bone mineral density of peripheral bones, such as the heel, shin bone and kneecap. But the bone mineral density in the spine or hip changes faster than that in the peripheral bones. Thus, quantitative ultrasound is considered to be not as accurate or sensitive as DEXA in the determination of bone mineral density. DEXA allows early detection of abnormal change in bone mass for its targets (spine, hip or whole body). But quantitative ultrasound offers the advantages of being low cost and radiation-free.

U.S. Patent Application No. 2005/0059875 (Chung) describes a biosensor and method for bone mineral density measurement.

U.S. Patent Application No. 2005/0031181 (Bi) is directed to a system and method for analyzing bone conditions using DICOM-compliant digital radiographic images.

U.S. Pat. No. 5,712,892 (Weil) is directed to an apparatus for measuring the bone mineral content of an extremity.

U.S. Pat. No. 6,711,282 (Liu) is directed to a method for automatically segmenting a target bone from a digital image, and references a bone density measurement system.

There is a need for on-site screening that can be utilized by physicians, radiologists, or other medical professionals locally at their offices to generate a bone mineral density report. A suitable system would need to be simple, reduced in cost, yet provide accuracy.

Based on the foregoing, there is a need for a system and method for bone mineral density screening

The present invention is a system directed to providing bone mineral density screening as well as mammography CAD for film x-ray input.

### SUMMARY OF THE INVENTION

An object of the present invention is to provide a system suitable for both bone mineral density screening and mammography CAD for film x-ray input.

Any objects provided are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method of analyzing a radiograph. The method includes the steps of: providing a digital image based on the radiograph; determining whether a radiographic absorptiometry analysis or computer aided detection analysis is desired; and performing a radiographic absorptiometry analysis or computer aided detection analysis on the digital image based on the desired determination.

According to another aspect of the invention, there is provided a system adapted to analyze a radiograph. The system includes an input station, a report station, and a printer. The input station is adapted to generate or accept a digital image based on the radiograph and includes: (a) means for digitizing the radiograph to generate the digital image, (b) means for determining whether to conduct a radiographic absorptiometry analysis or computer aided detection analysis of the digital image of the radiograph; (c) a radiographic absorptiometry application; (d) a computer aided detection application; and (e) means for applying the radiographic absorptiometry application or the computer aided detection application to the digital image based on the determination. The report station is adapted to provide a computer aided detection report. The printer is adapted to provide to print a radiographic absorptiometry report and a computer aided detection report.

According to another aspect of the present invention, there is provided a method of analyzing a radiograph. A digital image based on the radiograph is provided. A determination is made as to whether a radiographic absorptiometry analysis or computer aided detection analysis of the radiograph is desired whereby a radiographic absorptiometry analysis or computer aided detection analysis on the digital image is conducted based on the desired determination.

### BRIEF DESCRIPTION OF THE DRAWINGS

The foregoing and other objects, features, and advantages of the invention will be apparent from the following more particular description of the embodiments of the invention, as illustrated in the accompanying drawings.

The elements of the drawings are not necessarily to scale relative to each other.

FIG. 1 shows a film-screen mammography CAD system.

FIG. 2 shows a film-screen radiographic absorptiometry system.

FIG. 3 shows an integrated mammography CAD and radiographic absorptiometry system in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

The present invention is directed to an integrated system for radiographic absorptiometry (RA) based BMD (Bone Mineral Density) screening and Mammography CAD (Computer Aided Detection) for film-screen x-ray input.

Computer aided detection has been employed in the area of mammography. An example of such a CAD system is the Kodak Mammography CAD System.

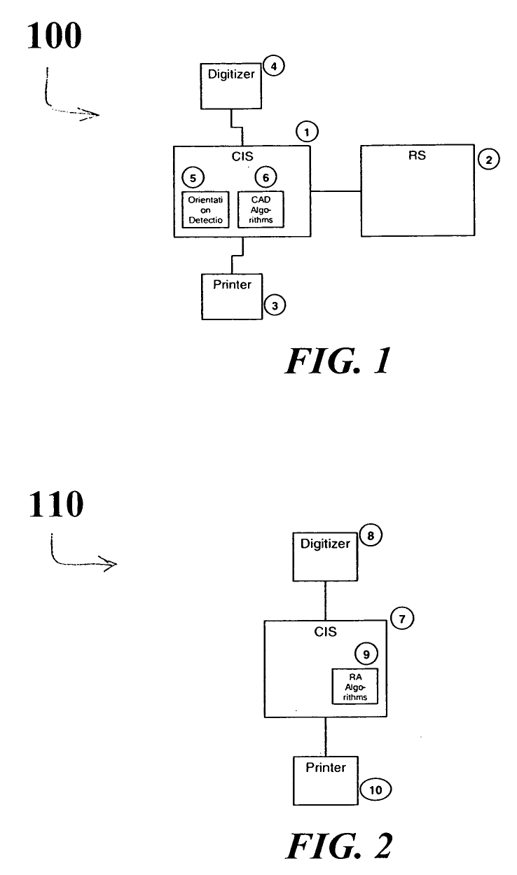

FIG. 1 generally illustrates a film-screen based Mammography CAD system 100 including a Case Input Station (CIS) (shown as element 1) and a Report Station (RS) (shown as element 2). The Case Input Station provides for film digitization and image analysis/processing. Report Station 2 is used by the radiologist to review the analyzed/processed image. U.S. Patent Application No. 2004/0024292 (Menhardt) more particularly describes features of a mammography CAD system.

A printer 3 can be connected to CIS 1 whereby reports can be printed on paper or other hardcopy media.

A high-resolution film digitizer 4 can be in communication with the CIS to accept and digitize the film. Such film digitizers are well known to those skilled in the art.

In a typical mammography CAD operation, a mammography case includes four mammographic images. Such images can be digital images acquired directly. Though typically, the images are obtained by digitizing four films/x-rays (i.e., feeding four films into a digitizer). Accessing the digital images, a CIS software 5 can automatically recognize the orientation and laterality of each of the four digitized images. The images are then processed by a CAD algorithm 6, which identifies candidate areas of suspicion for breast cancer on the images. The findings can then be either printed as an overlay to the images, or transferred by means of a communication network to Report Station 2.

When a radiologist reviews mammogram films on a light box or alternator, the radiologist will typically first read the films, and then turn to the CAD print-out or Report Station 2 to see whether the CAD system has identified areas of suspicion that may have been overlooked.

Radiographic Absorptiometry systems are known. Referring now to FIG. 2, a film-screen based Radiographic Absorptiometry (RA) system 110 includes a Case Input Station (CIS) (shown as element 7) for film digitization and image analysis/processing. After digitization of an x-ray film using a digitizer 8, RA software algorithms 9 on CIS 7 can calculate desired absorption parameters in accordance with methods known to those skilled in the art. Other desired data related to bone mineral density can also be calculated using methods known to those skilled in the art. These results can be sent to a printer 10 that is connected to the CIS 7.

In operation, an x-ray of a skeletal body part is acquired. Such an image can be taken together with calibration markers. For example, for screening purposes, a hand might be a preferred body part for review/examination. The x-ray is fed into the digitizer, and a report is printed. The radiologist can then review the report and determine whether follow-up is required.

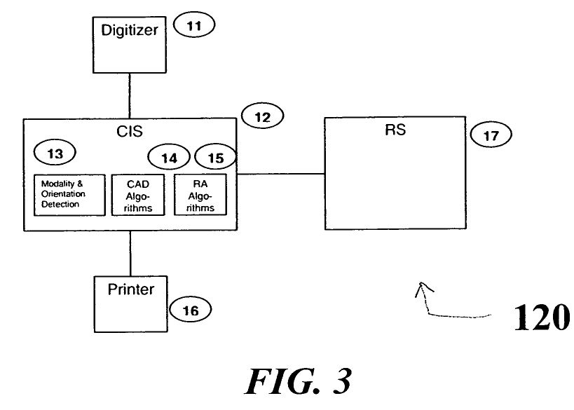

Referring now to FIG. 3, the present invention integrates elements of the above described systems.

In a system 120 of the present invention shown in FIG. 3, a user digitizes either/both a set of mammography films or a skeletal/screening x-ray using a high-resolution digitizer 11 in communication with a Case Input Station (CIS) (shown as element 12). A user interface of CIS 12 can provide a mechanism to indicate to system 120 what type of case (i.e., CAD or RA) it is. Alternatively, an automated Modality and Orientation Detection 13 software system can be employed to identify the type of case. Such software can, for example, analyze the content of the digital image to detect mammography content or skeletal content.

Based on the determination of modality (i.e., mammography or radiographic absorptiometry), the images can be directed either to the CAD algorithms 14 or the RA Algorithms 15. The results can then be sent on to a printer 12, or, optionally in the case of mammography, to a Report Station 17.

Accordingly, the present invention is directed to a system adapted to analyze a radiograph for radiographic absorptiometry and/or computer aided detection. The system includes an input station, a report station, and a printer. The input station is adapted to accept a digital image based on the radiograph. A scanner can be in communication with the input station to digitize the radiographs.

The input station includes means for determining whether to conduct a radiographic absorptiometry analysis or computer aided detection analysis of the radiograph. Such means can be a user interface of the input station, whereby a user indicates which type of analysis is desired. Alternatively, such means can software adapted to determine whether the content of the digital image is a mammogram, whereby the computer aided detection application is applied to the digital image if the content of the digital image is determined to be a mammogram, otherwise the radiographic absorptiometry application is applied to the digital image.

The input station further includes: a radiographic absorptiometry application, a computer aided detection application, and means for applying the radiographic absorptiometry application or the computer aided detection application to the digital image based on the determination.

The report station is adapted to provide a computer aided detection report for the review of a radiologist, as known to those skilled in the art. The printer is adapted to provide a hardcopy radiographic absorptiometry report. The printer can also be configured to provide a hardcopy computer aided detection report.

In operation, the system analyzes the radiograph by first accessing a digital image based on the radiograph. A determination is made as to whether a radiographic absorptiometry analysis or computer aided detection analysis is desired. After the determination is made, the appropriate analysis is conducted, that is, a radiographic absorptiometry analysis or computer aided detection analysis on the digital image is performed on the digital image based on the desired determination. A hardcopy printout of the analysis can be provided, or in the case of a computer aided detection, a softcopy report can be provided to a report station for review by a radiologist.

Accordingly, the present invention provides an integrated system for the bone mineral density screening as well as for mammography CAD.

All documents, patents, journal articles and other materials cited in the present application are hereby incorporated by reference.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method of analyzing a radiograph, the method comprising the steps of:
providing a digital image based on the radiograph;
determining whether a radiographic absorptiometry analysis or computer aided detection analysis is desired; and
performing a radiographic absorptiometry analysis or computer aided detection analysis on the digital image based on the desired determination.

2. The method of claim 1, further comprising the step of generating a report of the performed analysis.

3. The method of claim 1, wherein the step of determining is accomplished by allowing a user to indicate whether the radiographic absorptiometry analysis or the computer aided detection analysis is desired.

4. The method of claim 1, wherein the step of determining is accomplished by analyzing the digital image and determining that a computer aided detection analysis is desired if the content of the digital image is a mammogram.

5. The method of claim 1, wherein the step of determining is accomplished by analyzing the digital image and determining that a radiographic absorptiometry analysis is desired if the content of the digital image is not a mammogram.

6. The method of claim 1, wherein the step of providing a digital image is accomplished by scanning the radiograph.

7. The method of claim 1, wherein the step of performing a computer aided detection analysis on the digital image is accomplished by applying a CAD application to the digital image.

8. A computer storage product having at least one computer storage medium having instructions stored therein causing one or more computers to perform the method of claim 1.

9. A system adapted to analyze a radiograph, comprising:
an input station adapted to accept a digital image based on the radiograph and including:
(a) means for determining whether to conduct a radiographic absorptiometry analysis or computer aided detection analysis of the radiograph;
(b) a radiographic absorptiometry application;
(c) a computer aided detection application; and
(d) means for applying the radiographic absorptiometry application or the computer aided detection application to the digital image based on the determination;
a report station adapted to provide a computer aided detection report; and
a printer adapted to print a radiographic absorptiometry report and a computed aided detection report.

10. The system of claim 9, further including a scanner to scan the radiograph to generate the digital image based on the radiograph.

11. The system of claim 9, wherein the means for determining whether to conduct the radiographic absorptiometry or computer aided detection analysis is a user interface for the input station.

12. The system of claim 9, wherein the means for determining whether to conduct the radiographic absorptiometry or computer aided detection analysis includes means adapted to determine whether the content of the digital image is a mammogram, whereby the computer aided detection application is mammogram, otherwise the radiographic absorptiometry application is applied to the digital image.

13. A system adapted to analyze a radiograph, comprising:
(a) means for determining whether to conduct a radiographic absorptiometry analysis or computer aided detection analysis of the radiograph;
(b) a radiographic absorptiometry application;
(c) a computer aided detection application; and
(d) means for applying the radiographic absorptiometry application or the computer aided detection application to the digital image based on the determination.

14. The system of claim 13, further comprising: a report station adapted to provide a computer aided detection report; and a printer adapted to print a radiographic absorptiometry report and a computed aided detection report.
